(19) United States
(12) Patent Application Publication
(10) Pub. No.: US 2025/0251921 A1
(43) Pub. Date: Aug. 7, 2025

(54) Multicore Processors with Resource Sharing Clusters for AI Acceleration

(71) Applicant: Tenstorrent USA, Inc., Austin, TX (US)

(72) Inventors: Syed Gilani, Toronto (CA); Ivan Matosevic, Toronto (CA); Matthew Mattina, Boylston, MA (US)

(21) Appl. No.: 19/045,793

(22) Filed: Feb. 5, 2025

Related U.S. Application Data
(60) Provisional application No. 63/549,720, filed on Feb. 5, 2024.

(51) Int. Cl. G06F 8/41

(52) U.S. Cl. CPC G06F 8/4441; G06F 8/427

(57) ABSTRACT

Systems and methods related to multicore processors with resource sharing clusters for AI acceleration are disclosed herein. The clusters can be clusters of cores in the multicore processor. The clusters of cores may be configurable. The configuration may be based on the characteristics of a specific computation, for example, the cores in a cluster all needing access to the same network data or the output of one core in a cluster being required as the input to another core in the cluster. A compiler may be programmed to group a set of cores into a set of clusters, wherein each cluster in the set of clusters is assigned a shareable resource from a set of shareable resources. The compiler may also be programmed to generate configuration instructions to assign the set of cores to the set of clusters. Accordingly, the set of cores may be organized efficiently for the computation.

### CROSS REFERENCE TO RELATED APPLICATIONS

This application claims the benefit of U.S. Provisional Patent Application No. 63/549,720, filed Feb. 5, 2024, which is incorporated by reference herein in its entirety for all purposes.

### BACKGROUND

Many computing systems that are directed to accelerating artificial intelligence (AI) workloads, such as the execution of an artificial neural network (ANN) use the paradigm of distributed parallel computing embodied by, for example, a multicore processor. More generally, these systems can be referred to as a network of computational nodes. In a multicore processor, collaboration among multiple cores is essential for efficiently executing ANNs. The parallel architecture of multicore processors allows for simultaneous processing of different portions of the ANN, significantly speeding up training and inference tasks. During the execution of an ANN, various layers and operations can be divided among the available cores, enabling concurrent computation and reducing overall processing time. The cores collaborate through efficient communication mechanisms, such as Networks-on-Chips (NoCs). Coordinated data sharing and synchronization mechanisms are implemented to ensure that intermediate results are exchanged seamlessly, enabling the collective execution of complex neural network models. This collaborative approach optimizes the utilization of available computational resources, enhances parallelism, and contributes to the overall acceleration of AI workloads on multicore processors.

However, despite the advantages of parallelism in multicore processors for ANN execution, efficient data sharing among cores presents a significant challenge. Coordinating the flow of data, particularly data associated with large quantities of network data and intermediate results in the form of activation data, requires careful consideration of communication overhead and synchronization. The interconnectedness of processing cores in a multicore system demands sophisticated communication architectures, like NoCs, to manage the exchange of information without introducing bottlenecks. Balancing the distribution of tasks across cores and minimizing data movement latency is crucial for achieving optimal performance. Additionally, the intricacies of maintaining cache coherence in shared memory architectures can pose challenges, potentially impacting the efficiency gains of parallel processing. Therefore, addressing the complexities of data sharing becomes a critical aspect in the design and optimization of multicore processors for executing neural networks.

### SUMMARY

Systems and methods related to clusters of computational nodes for the execution of artificial intelligence workloads are disclosed herein. In specific embodiments, the clusters of computational nodes can be processing cores in a multicore processor. The computational nodes can be grouped into clusters where the clusters share common resources such as a shared memory or shared network resources (e.g., routers or network interface units). The shared memory can be a cache memory such as a level 2 cache.

Networks of computational nodes that use clusters with shared resources, such as a shared memory, can be beneficial for artificial intelligence workloads because the output of one computational node is often the input to the next computational node. For example, a first computational node could be conducting computations for a first layer of an ANN and a second computational node could be conducting computations for a second layer of an ANN and the second core could start executing as soon as a portion of the data was available as an output from the first layer. As another example, the first computational node could be conducting a large number of multiplication operations and the second computational node could be accumulating the calculated values. In either case, the use of a shared resource such as a shared cache is beneficial because the outputs of one computational unit are readily available to be used as the inputs of a second computational unit.

Networks of computational nodes that use clusters with shared resources, such as a shared network resources, can also be beneficial for artificial intelligence workloads because the workloads of the individual core in the cluster may depend on data from the common cores in the cluster with the overall cluster sharing an input from and an output to the broader network of computational nodes. For example, the cluster of computational nodes may execute a layer of an ANN with the input data from the rest of the computational nodes arriving at a shared resource and the product of the cluster of computational nodes can be sent off and out of the cluster using that same shared resource.

In specific embodiments of the invention, the groupings of the computational nodes into clusters can be configurable by software or by microcode instructions that are delivered to the computational nodes during initialization of the network of computational nodes for a given complex computation or during execution of a complex computation. For example, based on the characteristics of a specific ANN that will be executed using a network of computational nodes, the network of computational nodes can be gathered into different clusters. This configurable clustering can be conducted based on the computational nodes in the cluster all needing access to the same network data. Alternatively, or in combination, the configurable clustering can be conducted based on the output of one of the computational nodes in the cluster being required as the input to another one of the computational nodes in the cluster. The specific clusters can be determined by a compiler when preparing instructions to execute an artificial intelligence workload such as an ANN.

In specific embodiments of the invention, a system is provided. The system comprises: a set of processing cores, a network that connects the set of processing cores, a compiler programmed to generate a set of instructions for executing a complex computation using the set of processing cores, and a set of shareable resources; wherein the compiler is further programmed to: (i) group the set of processing cores into a set of clusters, wherein each cluster in the set of clusters is assigned a shareable resource from the set of shareable resources; and (ii) generate configuration instructions to assign the set of processing cores to the set of clusters.

In specific embodiments of the invention, a computer-implemented method is provided. The method comprises parsing a description of a complex computation to be executed by a set of processing cores that are connected together by a network and grouping the set of processing cores into a set of clusters, based on the description and the parsing, wherein each cluster in the set of clusters has a shareable resource from a set of shareable resources. The method further comprises: generating, based on the description and the parsing, a set of instructions for executing the complex computation using the set of processing cores; generating, based on the description and the parsing, a set of configuration instructions to assign the set of processing cores to the set of clusters; and providing the set of instructions and the set of configuration instructions to the set of processing cores for execution.

In specific embodiments of the invention, a system for executing a neural network is provided. The system comprises a set of processing cores, wherein the set of processing cores are divided into a set of clusters. The system further comprises a set of shared memory resources storing neural network data of the neural network, wherein the shared memory resources in the set of shared memory resources are uniquely associated with the clusters in the set of clusters. The processing cores in the clusters of processing cores are assigned a set of execution instructions for executing a neural network. The clusters in the set of clusters are dynamically formed based on the processing cores in the clusters of processing cores requiring access to a common subset of the neural network data. A first processing core in a cluster of processing cores generates activation data for consumption by a second processing core in the cluster of processing cores.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of a network of processing cores in accordance with specific embodiments of the inventions disclosed herein.

FIG. 2 provides an example of a compiler generating configuration instructions to assign a set of processing cores to a set of clusters in accordance with specific embodiments of the inventions disclosed herein.

FIG. 3 provides an example of a compiler generating instructions for executing a complex computation in accordance with specific embodiments of the inventions disclosed herein.

FIG. 4 provides an example of a system including multiplexers to group processing cores into clusters in accordance with specific embodiments of the inventions disclosed herein.

FIG. 5 provides an example of a tiling pattern for a set of processing cores and a set of shareable resources in accordance with specific embodiments of the inventions disclosed herein.

FIG. 6 provides an example of a method of grouping a set of processing cores into a set of clusters in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for multicore processors with resource sharing clusters for AI acceleration in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Specific embodiments of the invention disclosed herein are described with reference to a set of processing cores in a multicore processor executing a complex computation in parallel. The processing cores of a multicore processor can cooperatively execute complex computations by executing component computations of that complex computations in distributed fashion across the processing cores. To do so, the processing cores need to share data required for the execution of those component computations as well as receive instructions regarding which component computations they have been assigned. The processing cores can share this information using an interconnect fabric such as a network-on-Chip (NoC). The same network can be used to load the individual processing cores with their instructions and to provide them with the initial data to execute the computation. A multicore processor, including the various processing cores and the interconnect fabric which connects them, provides a basis for explaining various embodiments of the invention disclosed herein. However, while the example of a set of cores of a multicore processor is used as an example throughout this disclosure, specific embodiments of the invention disclosed herein are more broadly applicable to any set of computational nodes connected using any form of interconnect fabric or network.

Specific embodiments of the invention disclosed herein are described with reference to a complex computation. A complex computation may be a directed graph. In particular, the directed graph could be an ANN such as a convolutional neural network (CNN), a residual neural network (ResNet), recursive neural network (RNN), attention network, embedding, or any form of ANN. As such, the complex computation can involve the generation of an inference from the ANN in response to a given input. The execution can occur during a training phase of the ANN or after the network has been trained and deployed. The computation data in these embodiments includes the input data to the ANN, the execution data (e.g., activation data that is passed from one layer of the network to the next), the network data (e.g., weight or filter data) that defines the network, and the output data which is ultimately produced from the execution of the ANN. Although the example of an ANN is used for explaining various embodiments of the invention disclosed herein, specific embodiments of the invention disclosed herein are more broadly applicable to any complex computation including those used in association with graphics renderings, cryptographic algorithms, and big data computations generally.

A cluster may be a group of interconnected computational nodes, such as processing cores, that work together to perform tasks. Combining multiple processing cores to work together as a unified system may lead to improved performance, scalability, reliability, and availability for various computing tasks. Clusters may be used for many fields including high-performance computing, cloud computing, big data processing, and AI training. A cluster may distribute workload across multiple nodes, enabling faster computation than a single machine. If a node fails, the cluster may automatically reroute tasks to functioning nodes. Cluster may be able to be scaled up (e.g., adding more power to each node) or scaled out (e.g., adding more nodes) to meet increasing computational demands. Clusters may help to distribute tasks evenly among nodes to prevent bottlenecks and optimize resource utilization. Clusters may allow distributed computing frameworks to process large datasets efficiently and may enable large-scale AI training and interference. Clusters may be used for distributed storage to provide scalable and fault-tolerant data storage and in cloud platforms to provision virtual machines and containerized services. Small clusters may process data locally at the edge of the network to reduce latency and bandwidth usage.

Each cluster may contain one or more processing cores. There may be a default number of processing cores in a cluster, however a cluster may have more or less processing cores than the default number. For example, a deviation from the default the number of processing cores in a cluster may be based on the resource needs of the processing cores or the data flow between processing cores. The default or actual quantity of processing cores in a cluster may depend on the type of workload the cluster is designed to handle. Different applications may have varying levels of parallelism and resource demands. For very parallel workloads, tasks may be split across many cores with minimal inter-core communication, allowing for more cores per cluster. For tightly-coupled workloads requiring fast inter-core and inter-node communication, the processing core count of a cluster may balance memory bandwidth and network latency. Some workloads may require high memory bandwidth, limiting how many cores may be used efficiently in a cluster.

Systems and methods related to clusters of computational nodes for the execution of artificial intelligence workloads are disclosed herein. In specific embodiments, the clusters of computational nodes can be processing cores in a multicore processor. The computational nodes can be grouped into clusters where the clusters share common resources such as a shared memory or shared network resources (e.g., routers or network interface units). The shared memory can be a cache memory such as a level 2 cache.

Networks of computational nodes that use clusters with shared resources, such as a shared memory, can be beneficial for artificial intelligence workloads because the output of one computational node is often the input to the next computational node. For example, a first computational node could be conducting computations for a first layer of an ANN and a second computational node could be conducting computations for a second layer of an ANN and the second core could start executing as soon as a portion of the data was available as an output from the first layer. As another example, the first computational node could be conducting a large number of multiplication operations and the second computational node could be accumulating the calculated values. In either case, the use of a shared resource such as a shared cache is beneficial because the outputs of one computational unit are readily available to be used as the inputs of a second computational unit.

Networks of computational nodes that use clusters with shared resources, such as shared network resources, can also be beneficial for artificial intelligence workloads because the workloads of the individual core in the cluster may depend on data from the common cores in the cluster with the overall cluster sharing an input from and an output to the broader network of computational nodes. For example, the cluster of computational nodes may execute a layer of an ANN with the input data from the rest of the computational nodes arriving at a shared resource and the product of the cluster of computational nodes can be sent off and out of the cluster using that same shared resource.

In specific embodiments of the invention, the groupings of the computational nodes into clusters can be configurable by software or by microcode instructions that are delivered to the computational nodes during initialization of the network of computational nodes for a given complex computation or during execution of a complex computation. For example, based on the characteristics of a specific ANN that will be executed using a network of computational nodes, the network of computational nodes can be gathered into different clusters. This configurable clustering can be conducted based on the computational nodes in the cluster all needing access to the same network data. Alternatively, or in combination, the configurable clustering can be conducted based on the output of one of the computational nodes in the cluster being required as the input to another one of the computational nodes in the cluster. The specific clusters can be determined by a compiler when preparing instructions to execute an artificial intelligence workload such as an ANN. Grouping clusters of processing cores according to the resources needed by those processing cores as well as by the data flow between cores may improve the efficiency of the system. For example, these configurations may lead to reduced overhead, reduced latency, and improved bandwidth utilization. These benefits may be maximized for each system as the configurations may be highly tailored to each system.

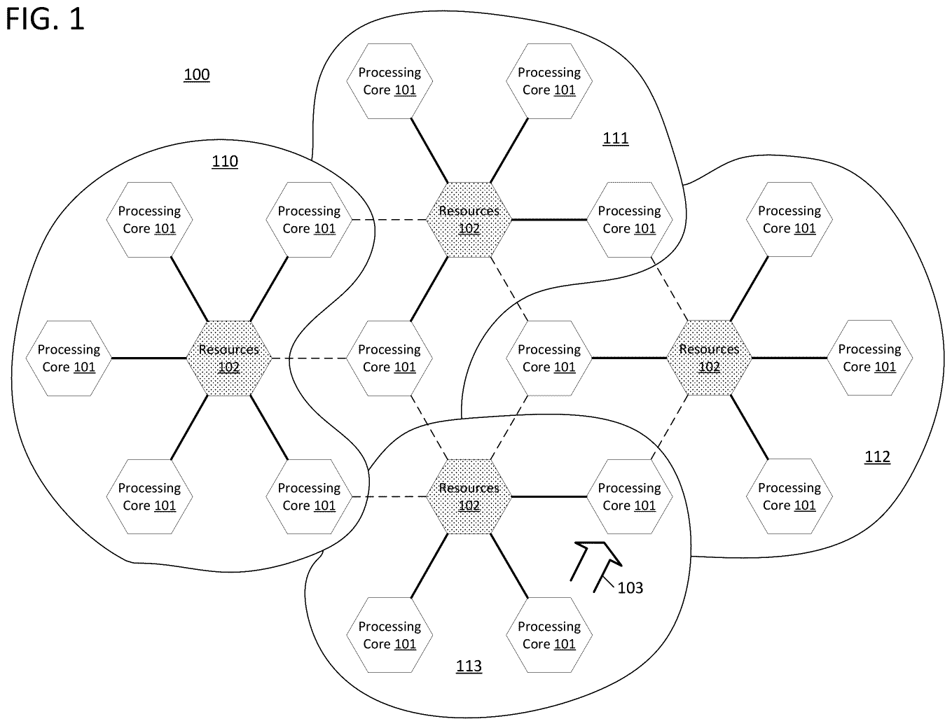

FIG. 1 provides an example of network 100 of processing cores 101 in accordance with specific embodiments of the inventions disclosed herein. Network 100 may execute a complex computation (e.g., a neural network). Network 100 includes a set of shareable resources 102. Processing cores 101 and shareable resources 102 are grouped into clusters 110, 111, 112, and 113. Although sixteen processing cores, four shareable resources, and four clusters are shown, network 100 may include any quantity of processing cores, shareable resources, and clusters. The organization of processing cores within the clusters is merely an example, as a cluster may include any quantity of processing cores in a variety of geometries. Thick solid lines show connections between processing cores 101 and their associated shareable resources 102. Dashed lines show connections between processing cores 101 and shareable resources 102 that may have been disabled due to the specific configuration of clusters. In specific embodiments, some processing cores 101 may be connected to each other directly, although these communication paths are not shown.

A description of the complex computation may be parsed. The parsed description may be an internal data structure. In specific embodiments, the description may be parsed by a compiler. The compiler may use a source code as an input and may perform lexical analysis, syntactic analysis, and semantic analysis. In specific embodiments, an instruction decode unit may parse and interpret binary instructions fetched from memory or cache and may translate machine instructions (e.g., opcodes) into microoperations. The instruction decode unit may identify the type of computation (e.g., arithmetic, memory access, branching) and the resources needed for the instructions. In specific embodiments, a control unit may manage the parsing and the execution of instructions (e.g., across the processor). The control unit may parse the sequence of instructions in the complex computation to determine the order of execution and may handle high-level coordination between functional units (e.g., arithmetic logic units, floating-point units, memory, etc.). In specific embodiments, a programmable logic unit may parse high-level computation descriptions and may configure the hardware to execute the described computation efficiently. In specific embodiments, a NoC controller may parse and route the description of the complex computation across the processing cores. The NoC controller may interpret and direct communication for the distributed computation, ensuring that tasks and data are sent to the appropriate processing core. In specific embodiments, a graphics processing unit (GPU) may parse and execute shader programs or compute kernels. In specific embodiments, AI accelerators may parse the complex computation. The AI accelerators may include units such as tensor cores and matrix multipliers. In specific embodiments, a memory management unit may parse memory-related portions of the complex computation such as virtual-to-physical address translations or data locality patterns.

The compiler may be programmed to generate a set of instructions for executing the complex computation using the set of processing cores 101. In specific embodiments, the complex computation may be part of a neural network. In specific embodiments, processing cores 101 in clusters 110-113 may be assigned a set of execution instructions for executing a neural network. The clustering of processing cores 101 may be related to (e.g., based on, organized for) the assigned set of execution instructions.

The compiler may be programmed to group the set of processing cores 101 into a set of clusters 110-113. The set of processing cores 101 may be divided into (e.g., among) clusters 110-113. Clusters 110-113 may be dynamically formed based on processing cores 101 in each cluster 110-113 requiring access to a common subset of the neural network data. Network data may be weight or filter data that defines the network. In specific embodiments of the invention, the groupings of processing cores 101 into clusters 110-113 can be configurable by software or by microcode instructions that are delivered to processing cores 101 during initialization of network 100 for a given complex computation or during execution of a complex computation. For example, based on the characteristics of a specific ANN that will be executed using network 100, processing cores 101 may be gathered into different arrangements of clusters. This configurable clustering can be conducted based on the processing cores 101 in the cluster all needing access to the same network data. Alternatively, or in combination, the configurable clustering can be conducted based on the output of one processing core 101 in a cluster (e.g., cluster 112) being required as the input to another processing core in the cluster (e.g., cluster 112). The specific clusters can be determined by a compiler when preparing instructions to execute an AI workload such as an ANN.

Each cluster 110-113 may be assigned a shareable resource 102 (e.g., from the set of four shareable resources 102 shown). In specific embodiments, network 100 may be a neural network and the shareable resources 102 may be shared memory resources storing neural network data of the neural network. Each shareable resource 102 may be uniquely associated with the clusters 110-113. Shareable resources 102 may include shared random-access memory (RAM), cache memory (e.g., L2, L3), virtual memory, non-volatile storage, floating-point units, graphics processing units, digital signal processors, buses, NoC interconnects, data channels, routers, disk controllers, network interfaces, input/output ports, accelerators, locks and semaphores, task schedulers, power management controllers, etc.

The compiler may be programmed to generate configuration instructions to assign the set of processing cores 101 to the set of clusters 110-113. The compiler may be programmed to identify a source code command to place a first processing core in the set of processing cores 101 and a second processing core in the set of processing cores 101 in a first cluster (e.g., cluster 110) in the set of clusters. The compiler may be programmed to generate at least one configuration instruction to assign the first processing core and the second processing core to the first cluster.

Processing cores 101 may be grouped into clusters based on various criteria. For example, a first processing core (e.g., processing core 101 in the lower right side of cluster 113) may generate activation data 103 for consumption by a second processing core (e.g., processing core 101 in the right side of cluster 113). The compiler may be programmed to make a determination that the first processing core will generate a threshold level of activation data 103 for consumption by the second processing core during the execution of the complex computation (e.g., neural network). The first processing core and the second processing core may be grouped together in the cluster (e.g., cluster 113) based on the determination. The determination may be made while the compiler parses the description of the complex computation.

Activation data may refer to data associated with the activation of a function, procedure, or method during its execution. Activation data may include intermediate results, task-specific data, synchronization data, and memory locality data. For task-specific data, each parallel task may need to store its own local data (e.g., partial computations or intermediate results). Synchronization data may include information necessary for coordinating and synchronizing between threads or nodes, ensuring data consistency or synchronizing tasks at specific points (e.g., barriers, lock mechanisms). In distributed system, activation data may also include pointers or references to data stored on different nodes, ensuring each node can continue its part of the computation without accessing other nodes' memory unnecessarily. The activation threshold may be based on a quantity of resources in the shared resources, a quantity of processing cores in the network, an average amount of activation data transferred between processing cores, a size of the complex computation, etc. The first processing core may be determined to meet or exceed threshold level of activation data for the compiling complex computation, triggering the first and second processing cores to be grouped together in a cluster.

In specific embodiments, the compiler may be programmed with a default number of processing cores 101 per cluster. The default number of processing cores 101 per cluster may be based on the type of workload, amount of parallelism, hardware constraints, node capacity, power consumption, heat dissipation, scaling, cluster management, load balancing, types of processors, and cost considerations. The compiler may be programmed to make a determination that the first processing core (e.g., processing core 101 in the lower right side of cluster 113) will generate a threshold level of activation data 103 for consumption by the second processing core (e.g., processing core 101 in the right side of cluster 113) during the execution of the complex computation (e.g., neural network). The compiler may be programmed to group the first processing core and the second processing core in a cluster (e.g., cluster 113) that has fewer than the default number of processing cores per cluster (e.g., three processing cores where the default is four) based on the determination. Shareable resources 102 may include routers and memory. By reducing the number of processing cores 101 in a cluster (e.g., to a number below the default), there may be more of the shareable resource 102 of the cluster per processing core 101 in that cluster. For example, if the compiler determines that a specific set of processing cores sends a lot of transmissions (e.g., activation data 103), fewer processing cores may be assigned to a router. As another example, if the compiler determines that a specific set of processing cores needs to use all available shared memory, fewer processing cores may be assigned to the cluster with that shared memory.

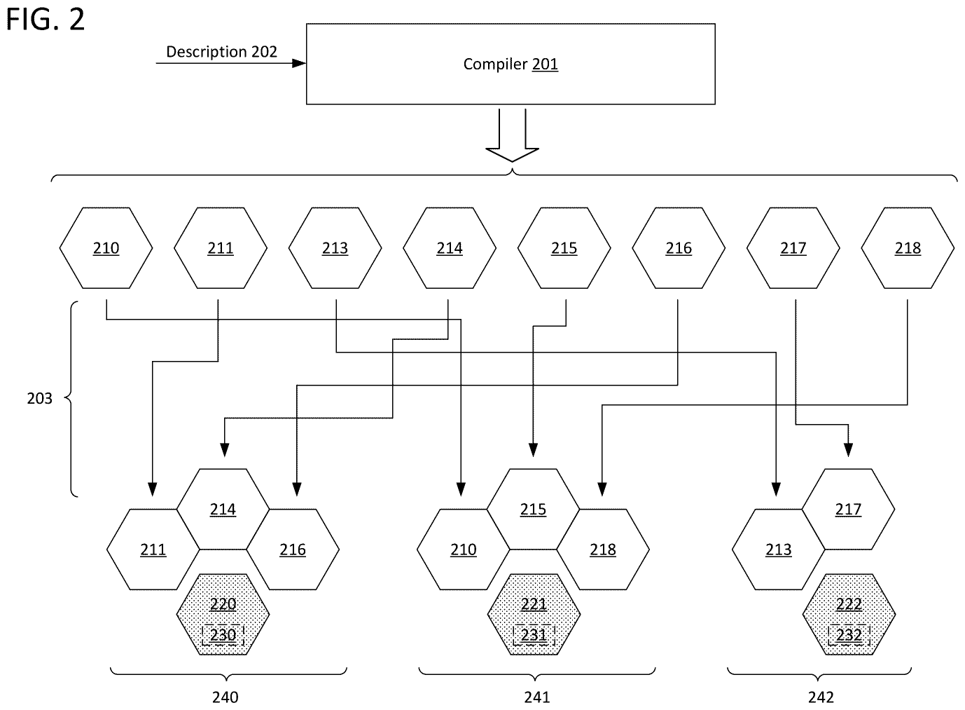

FIG. 2 provides an example of compiler 201 generating configuration instructions 203 to assign a set of processing cores 210-218 to a set of clusters 240-242 in accordance with specific embodiments of the inventions disclosed herein. Set of processing cores 210-218 may be connected by a network and may execute a complex computation. As illustrated, processing cores 211, 214, and 216 and shareable resource 220 are in cluster 240; processing cores 210, 215, and 218 and shareable resource 221 are in cluster 241; and processing cores 213 and 217 and shareable resource 222 are in cluster 242. FIG. 2 is exemplary only, as any number of processing cores may be grouped into any number of clusters of any size.

Description 202 of the complex computation may be parsed. In specific embodiments, description 202 may be parsed by compiler 201. In specific embodiments, a source command may be identified (e.g., by the compiler) during the parsing. The source code command may place a first processing core in the set of processing cores and a second processing core in the set of processing cores in a first cluster in the set of clusters. For example, the source code command may place processing core 211 and processing core 214 into cluster 240.

In specific embodiments, during the parsing, a determination may be determined (e.g., by compiler 201) that a first processing core will generate a threshold level of activation data for consumption by a second processing core during the execution of the complex computation (e.g., neural network). The first processing core and the second processing core may be grouped in a cluster in the set of clusters based on the determination. For example, processing core 210 may generate a threshold level of activation data for consumption by processing core 215 during the execution of the complex computation. Accordingly, a configuration instruction (in the set of configuration instructions 203) may group processing core 210 and processing core 215 together in cluster 241 based on the determination.

Cluster 242 may have fewer than a default number of processing cores. In specific embodiments, during the parsing, a determination may be determined (e.g., by compiler 201) that a first processing core will generate a threshold level of activation data for consumption by a second processing core during the execution of the complex computation (e.g., neural network). The first processing core and the second processing core may be grouped in a cluster in the set of clusters based on the determination. In specific embodiments, the cluster may have less than a default number of processing cores per cluster. For example, processing core 213 and processing core 217 may be grouped together in cluster 242 (e.g., by a configuration instruction in the set of configuration instructions 203) because processing core 217 is determined to have an amount of activation data equal to or more than a threshold amount of activation data for consumption by processing core 213. Cluster 242 may have only two processing cores (213 and 217) when the default number of processing cores per cluster may be three. By reducing the number of processing cores in a cluster below the default number, more shareable resource 222 may be allocated to processing cores 213 and 217 (without a third processing core to share shareable resource 222). For example, if compiler 201 determines that processing core 213 sends a lot of transmissions (e.g., activation data), fewer processing cores may be assigned to cluster 242, meaning fewer processing cores share a router of shareable resource 222. As another example, if compiler 201 determines that a processing cores 213 and 217 need to use all available shared memory of shareable resource 222, fewer processing cores may be assigned to cluster 242.

Compiler 201 may be programmed to group the set of processing cores 210-218 into a set of clusters 220-222. Compiler may group the set of processing cores 210-218 into a set of clusters 220-222 based on description 202 and the parsing. Compiler 201 may be programmed to generate configuration instructions 203 to assign the set of processing cores 210-218 to the set of clusters 240-242. Compiler 201 may generate configuration instructions 203 based on description 202 and the parsing. During the generating of the set of configuration instructions 203, at least one configuration instruction may be generated to assign a first processing core and a second processing core to a first cluster. For example, the configuration instruction may assign processing core 211 and processing core 214 into cluster 240. The configuration instruction may be based on a source code command. Configuration instructions 203 may be provided (e.g., by compiler 201) to the set of processing cores 210-218 for execution.

Each cluster 240, 241, and 242 may be assigned shareable resources 220, 221, and 222 respectively. In specific embodiments, shareable resources 220, 221, and 222 may include routers 230, 231, and 232 respectively. That is, the set of routers 230-232 may be uniquely associated with clusters 240-242. Routers 230-232 may route data for the complex computation through the network of processing cores 210-218. In specific embodiments, the set of shareable resources 220-222 may be a set of memories.

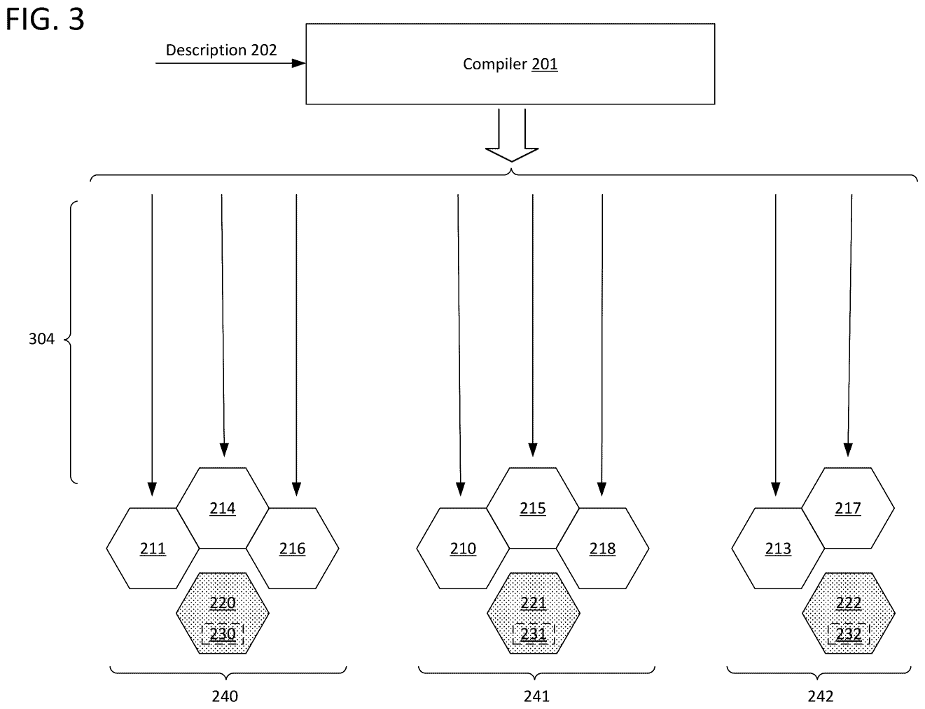

FIG. 3 provides an example of compiler 201 generating instructions 304 for executing a complex computation in accordance with specific embodiments of the inventions disclosed herein. Set of processing cores 210-218 may be connected by a network and may execute the complex computation. As illustrated, processing cores 211, 214, and 216 and shareable resource 220 are in cluster 240; processing cores 210, 215, and 218 and shareable resource 221 are in cluster 241; and processing cores 213 and 217 and shareable resource 222 are in cluster 242.

Description 202 of the complex computation may be parsed (e.g., by compiler 201). Compiler 201 may generate efficient code for complex computations via loop unrolling, inlining, and vectorization. Compiler 201 may group the set of processing cores 210-218 into a set of clusters 220-222 based on description 202 and the parsing. Compiler 201 may be programmed to generate a set of configuration instructions to assign the set of processing cores 210-218 to the set of clusters 240-242. Each cluster 240, 241, and 242 may be assigned shareable resources 220, 221, and 222 respectively. In specific embodiments, shareable resources 220, 221, and 222 may include routers 230, 231, and 232 respectively. In specific embodiments, the set of shareable resources 220-222 may be a set of memories.

Compiler 201 may be programmed to generate a set of instructions 304 for executing the complex computation (e.g., neural network) using the set of processing cores 210-218. Compiler 201 may generate the set of instructions 304 based on description 202 and the parsing. Instructions 304 may process data, perform calculations, manage memory, and control the flow of the program. For example, instructions 304 may perform matrix multiplication, perform recursive functions, solve a system of linear equations, pass large datasets between functions, perform Fourier transforms, perform deep learning, train an AI model, compute scientific simulations, process images, program machine learning, etc.

Instructions 304 may include a variety of instruction types. In specific embodiments, instructions 304 may include arithmetic and logic instructions such as addition, subtraction, multiplication, division, modulo, bitwise operations, and floating-point operations. In specific embodiments, instructions 304 may include control flow logic instructions such as branching, conditional branching, looping, exceptions, and interrupts. In specific embodiments, instructions 304 include memory management instructions such as load/store operations, stack operations, address calculation, and memory barriers. In specific embodiments, instructions 304 may include data movement instructions such as move data and push/pop. In specific embodiments, instructions 304 may include floating-point and single-instruction-multiple-data (SIMD) instructions such as vector operations and floating-point unit operations. In specific embodiments, instructions 304 may include synchronization and atomic instructions such as atomic operations, memory fences, and semaphore and mutex instructions. In specific embodiments, instructions 304 may include vector and matrix instructions such as dot product, matrix multiplication, and Fourier transforms. In specific embodiments, instructions 304 may include parallel and distributed execution instructions such as task dispatching, data partitioning, and reduce operations. In specific embodiments, instructions 304 may include vectorization instructions such as SIMD and GPU-specific instructions. The set of instructions 304 may be provided (e.g., by compiler 201) to the set of processing cores 210-218 for execution.

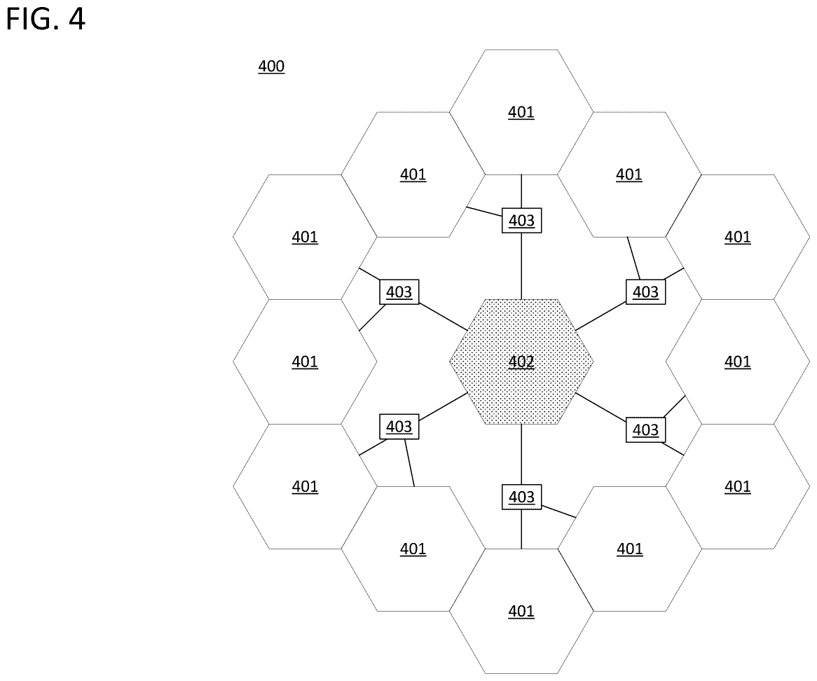

FIG. 4 provides an example of system 400 including multiplexers 403 to group processing cores 401 into clusters in accordance with specific embodiments of the inventions disclosed herein. A network may connect processing cores 401; and processing cores 401 may be used to execute a complex computation (e.g., neural network). Multiplexers 403 are one example of a configurable component in the system. In specific embodiments, multiplexers 403 may be replaced or supplemented with other components or manufacturing methods that allow different configurations of processing cores 401 such as antifuses, mask programming, laser fusing, electrical fusing, wire bonding, polysilicon fuses, programmable interconnects, reconfigurable logic, adaptive circuits, etc. Although twelve processing cores 401 are shown, system 400 may include any quantity of processing cores. Additionally, the processing cores may be connected via a variety of arrangements of multiplexers or other components.

One or more processing cores 401 may be part of a cluster including shareable resource 402 while other processing cores 401 are not. A compiler may be programmed to generate configuration instructions to assign various processing cores 401 to the cluster. Shareable resource 402 may include a router. The router may route data for the complex computation through the network. Shareable resource 402 may be a memory. Other shareable resources (not shown) forming part of the network may also include routers or be memories. The other shareable resources may be connected (e.g., coupled) to processing cores that are not part of the cluster such that each processing core 401 is connected to a shareable resource.

Processing cores 401 and shareable resource 402 may be organized in a tiling pattern. The tiling pattern may place each processing core 401 adjacent to a number of shareable resources (such as shareable resource 402 and others not shown). A set of configurable interfaces (e.g., including multiplexers 403) may be responsive to the configuration instructions and may enable each processing core 401 to be grouped into a number of different clusters. Specific processing cores 401 may be part of the cluster based on a description of the complex computation, the parsing of the description, the relationship of activation data between processing cores 401, the amount of resources in shareable resource 402, a default number of processing cores in a cluster, etc.

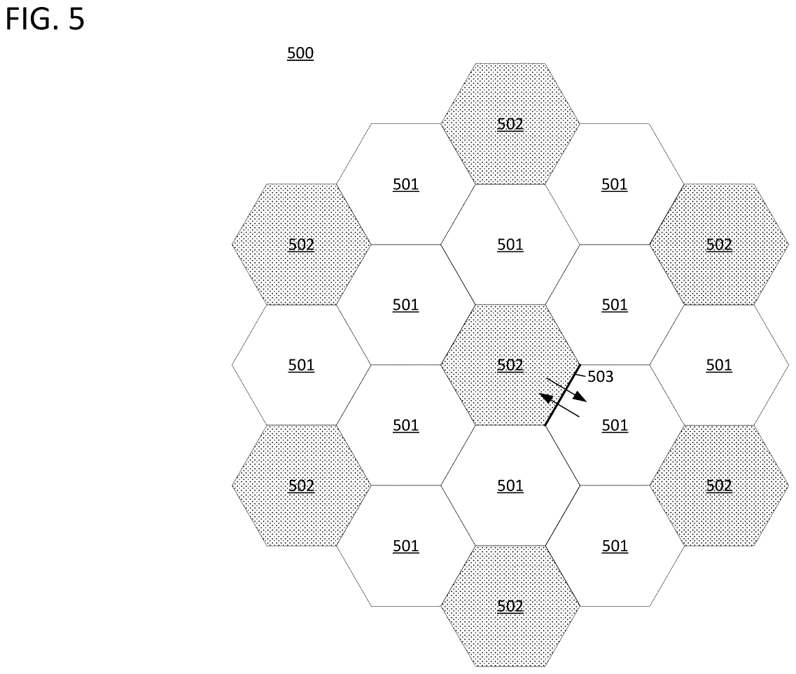

FIG. 5 provides an example of tiling pattern 500 for a set of processing cores 501 and a set of shareable resources 502 in accordance with specific embodiments of the inventions disclosed herein. Tiling pattern 500 is exemplary only, as other tiling patterns may be used. Additionally, processing cores 501 and shareable resources 502 may use different proportions of area in the network (e.g., the NoC) and different geometrical footprints. The tiling pattern may be periodic or aperiodic, and may incorporate a variety of geometries. Interface 503 is an example of an interface between components of tiling pattern 500. In the example of FIG. 5, interface 503 is between a shareable resource 502 and a processing core 501. The physical layout of tiles may be aligned with the way processing cores 501 are clustered.

Tiling pattern 500 may include physical components of the set of processing cores 501 and the set of shareable resources 502. Tiling pattern 500 may place each processing core 501 adjacent to a number of shareable resources 502. In the example of FIG. 5, each processing core 501 is adjacent to two shareable resources 502. A tile may communicate with other tiles. The computational workload may be distributed among the tiles to ensure that no processing core 501 is overloaded. Tiling pattern 500 may exploit the inherent spatial locality of computation, reduce communication overhead, and maximize cache efficiency. Tiling may minimize the amount of data that must be communicated between processing cores 501.

Each tile may have its own local cache and may interconnect links to other tiles in the network (e.g., on a NoC). The grouping of cores in clusters may be designed to reduce communication latency within the tile and enhance memory access speed. In specific embodiments, tiles may be distributed across nodes, and each node may process one or more tiles of data. A tile may include at least one processing core and one router (e.g., that is part of a shareable resource). The tile may also include at least one switch. In specific embodiments, the switches in each of the tiles may be connected to each other using one or more mesh networks. Clusters may be organized to minimize cache misses, minimize contention for shared resources, and maximize contiguous memory access. The network may be arranged in a mesh topology, ring or torus topology, hierarchical network, etc.

A set of configurable interfaces (e.g., interface 503) of processing cores 501 and shareable resources 502 may be responsive to configuration instructions. The configurable interface may enable each processing core 501 to be grouped into a number of different clusters (e.g., using the set of configurable instructions). Processing cores and shareable resource may be organized in a variety of ways. For example, a set of processing cores and a set of shareable resources may be organized into grid tiling (e.g., 2D grid, 3D grid), block tiling, linear/row-major layout, or clustered or tile-based layout. In specific embodiments, data may be split into blocks and each block may be processed by a node or machine in the cluster. In specific embodiments, each cluster of processing cores 501 may process a sub-matrix of a larger data set.

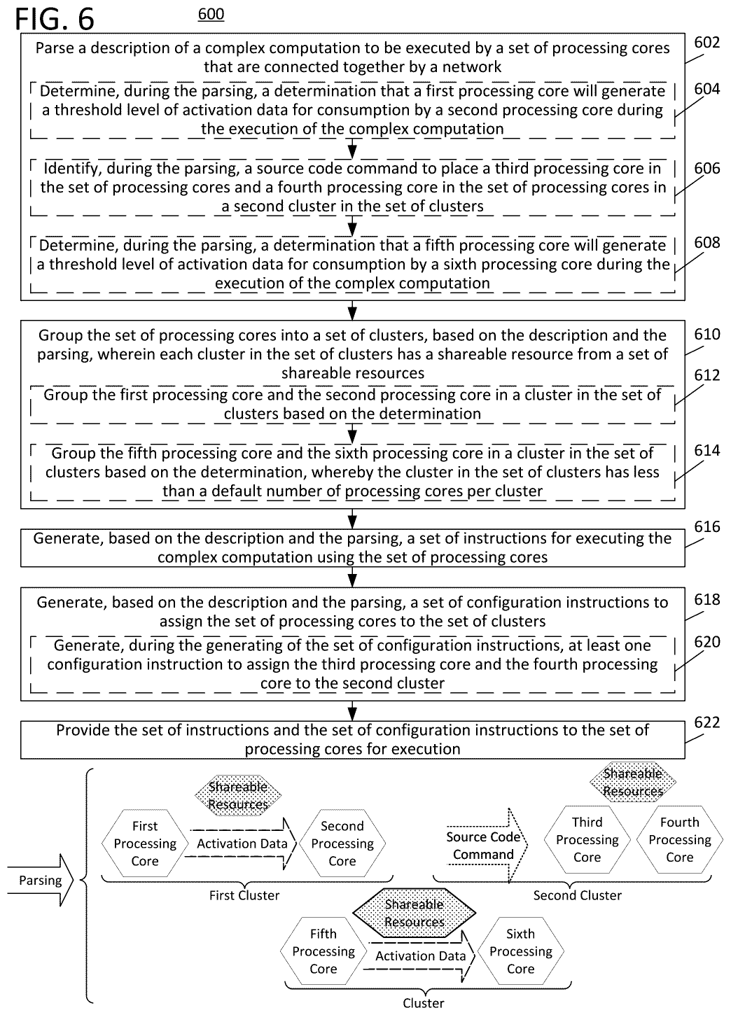

FIG. 6 provides an example of method 600 of grouping a set of processing cores into a set of clusters in accordance with specific embodiments of the inventions disclosed herein. Method 600 may be computer-implemented. Method 600 may be implemented by a system including a set of processing cores, a network that connects the set of processing cores, a compiler, and a set of shareable resources. In specific embodiments, the system may also include a set of routers, a set of memories, a tiling pattern, and a set of configurable interfaces. Method 600 may be implemented by a system including a set of processing cores and a set of shared memory resources. In specific embodiments the system may also include a source code command, a set of configuration instructions, a set of routers, a tiling pattern, and a set of configurable interfaces. Method 600 may be implemented by a system including means for performing the steps of method 600. Steps, or portions of steps, of method 600 may be duplicated, omitted, rearranged, or otherwise deviate from the form shone. Additional steps may be added to method 600. Steps, or portions of steps, of method 600 may be performed in series or parallel.

At step 602, a description of the complex computation may be parsed. The complex computation may be intended for execution by a set of processing cores that are connected together by a network. The description may be parsed by a compiler. In specific embodiments, the set of processing cores may be in a tiling pattern with a set of shareable resources. The tiling pattern may place each processing core adjacent to a number of shareable resources from the set of shareable resources.

In specific embodiments and as part of parsing the description, at step 604, a determination that a first processing core will generate a threshold level of activation data for consumption by a second processing core during the execution of the complex computation may be determined. The determination may be made by the compiler. Activation data may be intermediate results and may be passed from one layer of the network to the next.

In specific embodiments and as part of parsing the description, at step 606, a source code command may be identified. The source command may be to place a third processing core in the set of processing cores and a fourth processing core in the set of processing cores in a second cluster in the set of clusters. The determination may be made during the parsing (e.g., step 602). The determination may be made by the compiler.

In specific embodiments and as part of parsing the description, at step 608, a determination that a fifth processing core will generate a threshold level of activation data for consumption by a sixth processing core during the execution of the complex computation may be determined. Activation data may be intermediate results and may be passed from one layer of the network to the next. The determination may be made during the parsing (e.g., step 602). The determination may be made by the compiler.

At step 610, the set of processing cores may be grouped into a set of clusters. The set of processing cores may be grouped based on the description and the parsing (e.g., at step 602). Each cluster in the set of clusters may have a shareable resource from a set of shareable resources. The processing cores may be grouped by the compiler. In specific embodiments, the set of shareable resources may include a set of routers for routing data for the complex computation through the network. In specific embodiments, the set of shareable resources is a set of memories. In specific embodiments, the network may be a neural network and the shareable resources may be shared memory resources storing neural network data of the neural network. Network data may be weight or filter data that defines the network. In specific embodiments, the shared memory resources in the set of shared memory resources may be uniquely associated with the clusters in the set of clusters.

In specific embodiments and as part grouping the set of processing cores, at step 612, the first processing core and the second processing core may be grouped in a cluster in the set of clusters based on the determination (e.g., of step 604) that the first processing core will generate the threshold level of activation data for consumption by the second processing core during the execution of the complex computation. The first processing core and the second processing core may be grouped together by the compiler.

In specific embodiments and as part grouping the set of processing cores, at step 614, the fifth processing core and the sixth processing core may be grouped in a cluster in the set of clusters based on the determination (e.g., at step 608) that the fifth processing core will generate the threshold level of activation data for consumption by the sixth processing core during the execution of the complex computation. The cluster in the set of clusters may have less than a default number of processing cores per cluster. By having less than the default number of processing cores per cluster, there is more of the shared resource per processing core in the cluster. For example, if the fifth processing core sends a lot of activation data to the sixth processing core, then fewer processing cores may be assigned the cluster and therefore to the router (e.g., of the shareable resources). The fifth processing core and the sixth processing core may be grouped together by the compiler.

At step 616, a set of instructions may be generated. The set of instructions may be for executing the complex computation using the set of processing cores. The set of instructions may be generated based on the description and the parsing (e.g., at step 602) and may be generated by the compiler.

At step 618, a set of configuration instructions may be generated. The set of configuration instructions may assign the set of processing cores to the set of clusters. The set of configuration instructions may be generated based on the description and the parsing (e.g., at step 602). In specific embodiments, the set of configuration instructions may enable each processing core to be grouped into a number of different clusters using a set of configurable interfaces. The set of configurable interfaces may connect processing cores and shareable resources, which may be organized in a tiling pattern. The configuration instructions may be generated by the compiler.

In specific embodiments and as part of generating the set of configuration instructions, at step 620, at least one configuration instruction to assign the third processing core and the fourth processing core to the second cluster may be generated. The at least one configuration instruction may be generating during the generating of the set of configuration instructions (e.g., step 618).

At step 622, the set of instructions and the set of configuration instructions may be provided to the set of processing cores for execution. The set of instructions and the set of configuration instructions may be provided to the set of processing cores by the compiler.

Grouping clusters of processing cores according to the resources needed by those processing cores as well as by the data flow between cores may improve the efficiency of the system. For example, these configurations may lead to reduced overhead, reduced latency, and improved bandwidth utilization. These benefits may be maximized for each system as the configurations may be tailored to each system (e.g., to each complex computation).

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the scope of the present invention, which is more particularly set forth in the appended claims.

What is claimed is:

1. A system comprising:
a set of processing cores;
a network that connects the set of processing cores;
a compiler programmed to generate a set of instructions for executing a complex computation using the set of processing cores; and
a set of shareable resources;
wherein the compiler is further programmed to: (i) group the set of processing cores into a set of clusters, wherein each cluster in the set of clusters is assigned a shareable resource from the set of shareable resources; and (ii) generate configuration instructions to assign the set of processing cores to the set of clusters.

2. The system of claim 1, wherein:
the compiler is further programmed to: (i) make a determination that a first processing core will generate a threshold level of activation data for consumption by a second processing core during the execution of the complex computation; and (ii) group the first processing core and the second processing core in a cluster based on the determination.

3. The system of claim 1, wherein the compiler is further programmed to:
identify a source code command to place a first processing core in the set of processing cores and a second processing core in the set of processing cores in a first cluster in the set of clusters; and
generate at least one configuration instruction to assign the first processing core and the second processing core to the first cluster.

4. The system of claim 1, wherein:
the compiler is programmed with a default number of processing cores per cluster; and
the compiler is further programmed to: (i) make a determination that a first processing core will generate a threshold level of activation data for consumption by a second processing core during the execution of the complex computation; and (ii) group the first processing core and the second processing core in a cluster that has fewer than the default number of processing cores per cluster based on the determination.

5. The system of claim 1, further comprising:
a set of routers for routing data for the complex computation through the network;
wherein the set of shareable resources includes the set of routers.

6. The system of claim 1, further comprising:
a set of memories;
wherein the set of shareable resources is the set of memories.

7. The system of claim 1, further comprising:
a tiling pattern for the set of processing cores and the set of shareable resources, wherein the tiling pattern places each processing core adjacent to a number of shareable resources from the set of shareable resources; and
a set of configurable interfaces, responsive to the configuration instructions, that enables each processing core to be grouped into a number of different clusters.

8. A computer-implemented method comprising:
parsing a description of a complex computation to be executed by a set of processing cores that are connected together by a network;
grouping the set of processing cores into a set of clusters, based on the description and the parsing, wherein each cluster in the set of clusters has a shareable resource from a set of shareable resources;
generating, based on the description and the parsing, a set of instructions for executing the complex computation using the set of processing cores;
generating, based on the description and the parsing, a set of configuration instructions to assign the set of processing cores to the set of clusters; and
providing the set of instructions and the set of configuration instructions to the set of processing cores for execution.

9. The computer-implemented method of claim 8, further comprising:
determining, during the parsing, a determination that a first processing core will generate a threshold level of activation data for consumption by a second processing core during the execution of the complex computation; and
grouping the first processing core and the second processing core in a cluster in the set of clusters based on the determination.

10. The computer-implemented method of claim 8, further comprising:
identifying, during the parsing, a source code command to place a first processing core in the set of processing cores and a second processing core in the set of processing cores in a first cluster in the set of clusters; and
generating, during the generating of the set of configuration instructions, at least one configuration instruction to assign the first processing core and the second processing core to the first cluster.

11. The computer-implemented method of claim 8, further comprising:
determining, during the parsing, a determination that a first processing core will generate a threshold level of activation data for consumption by a second processing core during the execution of the complex computation; and
grouping the first processing core and the second processing core in a cluster in the set of clusters based on the determination, whereby the cluster in the set of clusters has less than a default number of processing cores per cluster.

12. The computer-implemented method of claim 8, wherein:
the set of shareable resources includes a set of routers for routing data for the complex computation through the network.

13. The computer-implemented method of claim 8, wherein:
the set of shareable resources is a set of memories.

14. The computer-implemented method of claim 8, wherein:
the set of processing cores are in a tiling pattern with the set of shareable resources;
the tiling pattern places each processing core adjacent to a number of shareable resources from the set of shareable resources; and
the set of configuration instructions enable each processing core to be grouped into a number of different clusters using a set of configurable interfaces.

15. A system for executing a neural network comprising:
a set of processing cores, wherein the set of processing cores are divided into a set of clusters; and
a set of shared memory resources storing neural network data of the neural network, wherein the shared memory resources in the set of shared memory resources are uniquely associated with the clusters in the set of clusters;
wherein the processing cores in the clusters of processing cores are assigned a set of execution instructions for executing a neural network;
wherein the clusters in the set of clusters are dynamically formed based on the processing cores in the clusters of processing cores requiring access to a common subset of the neural network data; and
wherein a first processing core in a cluster of processing cores generates activation data for consumption by a second processing core in the cluster of processing cores.

16. The system of claim 15, wherein:
the first processing core and the second processing core are grouped together in the cluster of processing cores based on a determination that the first processing core will generate a threshold level of the activation data for consumption by the second processing core during the execution of the neural network.

17. The system of claim 15, wherein:
a source code command places the first processing core and the second processing core in the cluster of processing cores; and
at least one configuration instruction assigns the first processing core and the second processing core to the cluster of processing cores.

18. The system of claim 15, wherein:
the first processing core and the second processing core are grouped together in the cluster of processing cores based on the first processing core generating a threshold level of the activation data for consumption by the second processing core during the execution of the neural network; and
the cluster of processing cores has fewer than a default number of processing cores per cluster.

19. The system of claim 15, further comprising:
a set of routers for routing data for the neural network;
wherein the set of routers are uniquely associated with the clusters in the set of clusters.

20. The system of claim 15, further comprising:
a tiling pattern for the set of processing cores and the set of shared memory resources, wherein the tiling pattern places each processing core adjacent to a number of shared memory resources from the set of shared memory resources; and
a set of configurable interfaces that enables each processing core to be grouped into a number of different clusters.
